(19) United States
(12) Patent Application Publication
(10) Pub. No.: US 2022/0317683 A1
(43) Pub. Date: Oct. 6, 2022

(54) REMOTE OPERATOR RECOMMENDATION SYSTEM AND REMOTE OPERATOR RECOMMENDATION METHOD

(71) Applicant: Woven Planet Holdings, Inc., Tokyo (JP)

(72) Inventor: Ryo IGARASHI, Tokyo-to (JP)

(73) Assignee: Woven Planet Holdings, Inc., Tokyo (JP)

(21) Appl. No.: 17/712,464

(22) Filed: Apr. 4, 2022

(30) Foreign Application Priority Data
Apr. 5, 2021 (JP) 2021-064326

(51) Int. Cl. G05D 1/00; G06Q 10/06

(52) U.S. Cl. CPC G05D 1/0033; G05D 1/0016; G06Q 10/06393; G06Q 10/06398; G05D 2201/0213

(57) ABSTRACT

The remote operator recommendation system identifies, using the matching model, an adapted remote operator having an operator attribute adapted to a user attribute of a requesting user requesting remote operation of a vehicle from among standby remote operators. Furthermore, the remote operator recommendation system predicts, using the collaborative filtering model, an expected remote operator who has not been used by the requesting user but is expected to be highly evaluated by the requesting user from among the standby remote operators. The remote operator recommendation system recommends the expected remote operator to the requesting user in addition to the adapted remote operator.

### CROSS-REFERENCE TO RELATED APPLICATION

The present application claims priority under 35 U.S.C. § 119 to Japanese Patent Application No. 2021-064326, filed Apr. 5, 2021, the contents of which application are incorporated herein by reference in their entirety.

### BACKGROUND

### Field

The present disclosure relates to a technique for recommending a remote operator who remotely operates a vehicle on behalf of a user, from among available remote operators, to a user who desires to use remote operation service.

### Background Art

Providing a remote operation service in which a remote operator remotely operates a vehicle on behalf of a user has been considered. JP2019-220744A discloses a prior art in which a plurality of remote operators chosen based on a result of comparing user attribute information with remote operator attribute information are presented to a user to cause the user to select one of the chosen remote operators.

According to the prior art described above, a remote operator adapted in attribute information is recommended to the user. However, only the remote operator adapted in attribute information is not necessarily a remote operator with high user satisfaction. For this reason, the prior art described above has room for improvement in user satisfaction with respect to a recommended remote operator.

As prior art documents representing the technical level of the technical field to which the present disclosure belongs, in addition to JP2019-220744A, WO2018/087828, JP2019-219723A, and JP2019-175209A can be exemplified.

### SUMMARY

The present disclosure has been made in view of the above-described problems. An object of the present disclosure is to provide a technique capable of recommending a remote operator who may improve user satisfaction to a user when the user uses remote operation service of a vehicle.

The present disclosure provides a remote operator recommendation system. The system of the present disclosure comprising a storage device storing a matching model and a collaborative filtering model, and at least one processor coupled to the storage device. The at least one processor is configured to execute identifying, using the matching model, an adapted remote operator having an operator attribute adapted to a user attribute of a requesting user requesting remote operation of a vehicle from among standby remote operators. Furthermore, the at least one processor is configured to execute predicting, using the collaborative filtering model, an expected remote operator who has not been used by the requesting user but is expected to be highly evaluated by the requesting user from among the standby remote operators. The at least one processor is configured to execute recommending the expected remote operator to the requesting user in addition to the adapted remote operator.

According to the present system configured as described above, a remote operator who has not been used by a requesting user but is expected to be highly evaluated by the requesting user is predicted using the collaborative filtering model. This makes it possible to recommend a new remote operator who may improve user satisfaction to the requesting user.

In the present system, the at least one processor may be configured to further execute, when the requesting user is a new user, recommending a remote operator with the highest number of times of remote operation among the standby remote operators. This makes it possible to recommend the most popular remote operator among available remote operators to the new user to satisfy the new user.

In the present system, the at least one processor may be configured to further execute, after a remote operator in charge finishes remote operation, accepting an evaluation of the remote operator in charge from the requesting user, and updating at least one of the matching model and the collaborative filtering model based on the evaluation of the remote operator in charge by the requesting user. This makes it possible to improve the accuracy of the matching model or the collaborative filtering model.

The present disclosure also provides a remote operator recommendation method. The method of the present disclosure comprises identifying, using a matching model, an adapted remote operator having an operator attribute adapted to a user attribute of a requesting user requesting remote operation of a vehicle from among standby remote operators. Furthermore, the method of the present disclosure comprises predicting, using a collaborative filtering model, an expected remote operator who has not been used by the requesting user but is expected to be highly evaluated by the requesting user from among the standby remote operators. The method of the present disclosure comprises recommending the expected remote operator to the requesting user in addition to the adapted remote operator.

Also, the present disclosure provides a non-transitory computer-readable storage medium storing a program configured to cause a computer to execute processing. The processing comprises identifying, using a matching model, an adapted remote operator having an operator attribute adapted to a user attribute of a requesting user requesting remote operation of a vehicle from among standby remote operators. Furthermore, the processing comprises predicting, using a collaborative filtering model, an expected remote operator who has not been used by the requesting user but is expected to be highly evaluated by the requesting user from among the standby remote operators. The processing comprises recommending the expected remote operator to the requesting user in addition to the adapted remote operator.

According to the present disclosure as described above, a remote operator who has not been used by a requesting user but is expected to be highly evaluated by the requesting user is predicted using the collaborative filtering model. This makes it possible to recommend a new remote operator who may improve user satisfaction to the requesting user.

### BRIEF DESCRIPTION OF THE DRAWINGS

FIG. 1 is a schematic diagram showing a configuration of a remote operation system according to an embodiment of the present disclosure.

FIG. 2 is a block diagram illustrating a configuration of a remote operator recommendation system according to the embodiment of the present disclosure.

FIG. 3 is a diagram for explaining a specific example of a collaborative filtering model.

FIG. 4 is a diagram for explaining the specific example of the collaborative filtering model.

FIG. 5 is a flow chart illustrating a remote operator recommendation method according to the embodiment of the present disclosure.

### DETAILED DESCRIPTION

Hereunder, embodiments of the present disclosure will be described with reference to the drawings. Note that when the numerals of numbers, quantities, amounts, ranges and the like of respective elements are mentioned in the embodiments shown as follows, the present disclosure is not limited to the mentioned numerals unless specially explicitly described otherwise, or unless the disclosure is explicitly designated by the numerals theoretically. Furthermore, structures that are described in the embodiments shown as follows are not always indispensable to the disclosure unless specially explicitly shown otherwise, or unless the disclosure is explicitly designated by the structures or the steps theoretically.

### 1. Configuration of Remote Operation System

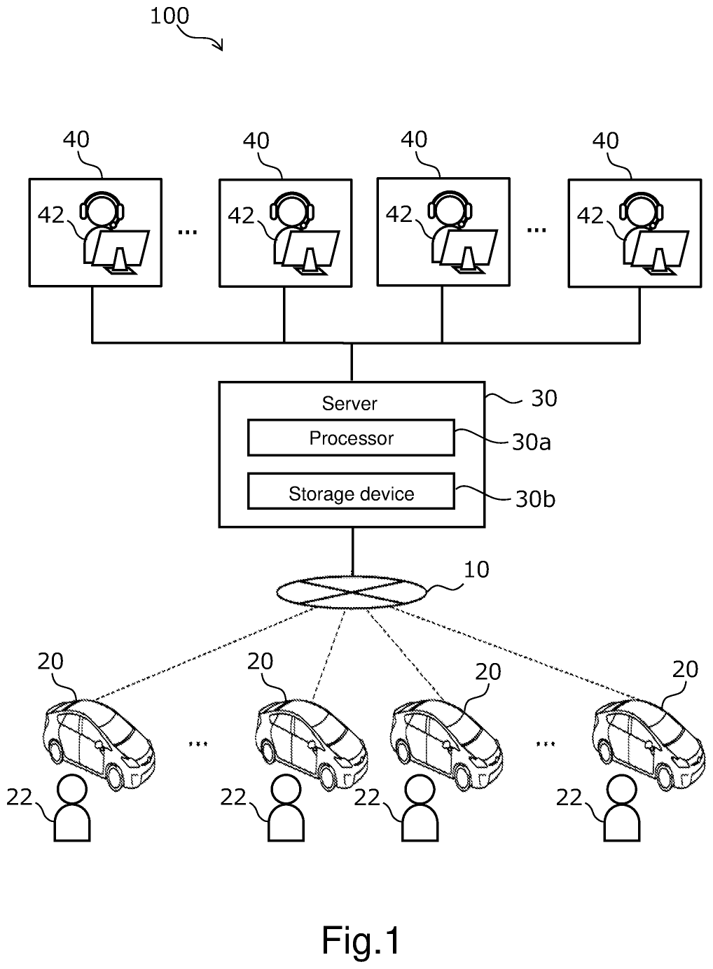

FIG. 1 is a schematic diagram showing a configuration of a vehicle remote operation system. The remote operation system 100 is a system that provides a remote operation service to a user 22. The user 22 of the remote operation service is a driver or occupant of a vehicle 20 to be remotely operated. The vehicle 20 to be remotely operated is preferably a vehicle capable of manual operation by the driver when remote operation is not performed, or a vehicle having an autonomous operation function. The vehicle 20 to be remotely operated may be, for example, a private car or a rental car.

In remote operation, recognition, determination, and operation necessary for operating the vehicle 20 is performed by a remote operator 42 instead of the user 22. Hereafter, the remote operator is simply referred to as an operator. The operator 42 includes an internal operator performing remote operation in a monitoring center, and an external operator who accesses the monitoring center from the outside to perform remote operation.

The operator 42 remotely operates the vehicle 20 in a remote operation seat 40. The remote operation seat 40 is equipped with a display for outputting an image and a speaker for outputting sound. The display displays, for example, an image ahead of the vehicle 20 taken by a camera of the vehicle 20. The speaker transmits, for example, a surrounding condition of the vehicle 20 collected by a microphone to the operator 42 by sound.

The remote operation seat 40 is equipped with a steering wheel for steering operation, an accelerator pedal for acceleration operation, and a brake pedal for deceleration operation. Also, if the vehicle 20 is equipped with a transmission, the remote operation seat 40 may be equipped with a lever or switch of the transmission. In addition, devices for performing operations necessary for safe driving such as an operation lever for operating a direction indicator of the vehicle 20 and an operation lever for operating a wiper are equipped in the remote operation seat 40.

The remote operation seat 40 operated by the operator 42 is connected to a server 30. The vehicle 20 to be remotely operated is connected to the server 30 via a communication network 10 including 4G and 5G. The server 30 includes at least one processor (hereinafter simply referred to as a processor) 30a and a storage device 30b coupled to the processor 30a. The storage device 30b stores one or more programs executable by the processor 30a and various related information.

The programs stored in the storage device 30b includes a program that causes the server 30 to function as a recommendation system that recommends the operator 42 to the user 22. The server 30 as a recommendation system recommends one or more operators 42 from among available operators 42 when the user 22 requests remote operation of the vehicle 20. By the user 22 selecting the operator 42, the remote operation seat 40 of the selected operator 42 and the vehicle 20 are connected via the communication network 10 to enable remote operation of the vehicle 20 by the operator 42.

### 2. Configuration of Remote Operator Recommendation System

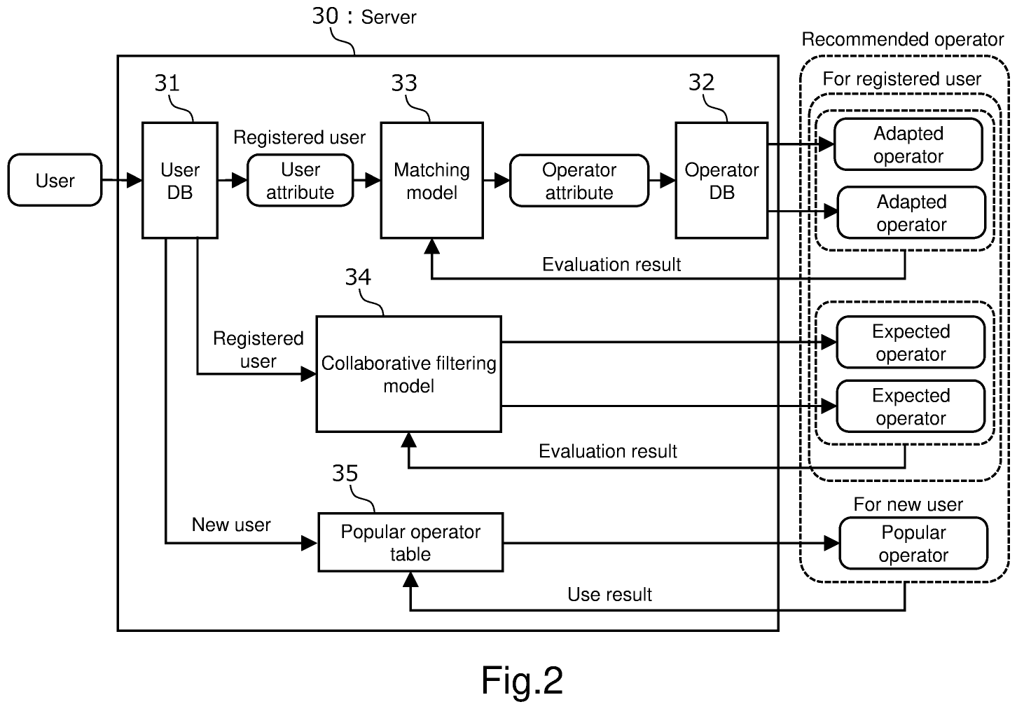

Hereinafter, a detailed configuration of the server 30 as the recommendation system will be described with reference to FIG. 2. The server 30 as the recommendation system includes a user database 31, an operator database 32, a matching model 33, a collaborative filtering model 34, and a popular operator table 35. These are stored in the storage device 30b.

The user database 31 is a database in which user attributes are registered for each user. The user attributes include, for example, the age and sex of the user, and types of vehicles used by the user. The types of vehicles include, for example, a standard-sized vehicle, a medium-sized vehicle, a large-sized vehicle, a large-sized special vehicle, a traction vehicle, and the like.

The operator database 32 is a database in which operator attributes are registered for each operator. The operator attributes include, for example, the age and sex of the operator, and types of licenses the operator has. The types of licenses include, for example, a standard-sized license, a medium-sized license, a large-sized licenses, a large-sized special license, a traction vehicle license, and the like.

The matching model 33 is a regression model using evaluation results of operators by users as objective functions and is created based on co-occurrence of user attributes and operator attributes as feature quantities. In the matching model 33, a relationship between user attributes and operator attributes satisfied by a large number of users is statistically modeled. The matching model 33 is updated on the basis of evaluation results of operators by users every time an evaluation result is newly obtained or when predetermined amounts of evaluation results are accumulated.

The user attribute of the user who has requested remote operation is identified using the user database 31. The identified user attribute is entered into the matching model 33, and operator attribute adapted to the user attribute is identified using the matching model 33. The identified operator attribute is entered into the operator database 32 and one or more operators having the identified operator attribute are selected from among the standby operators. Hereafter, the operator recommended using the user database 31, the matching model 33, and the operator database 32 is referred to as an adapted operator (adapted remote operator).

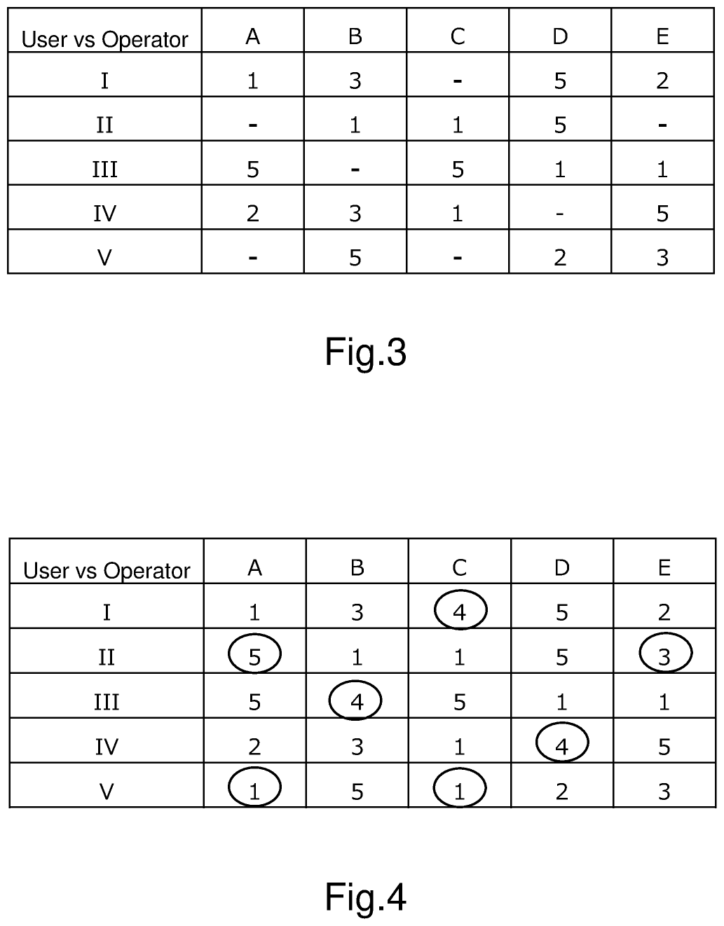

The collaborative filtering model 34 is a model that recommends an operator using collaborative filtering. The collaborative filtering model 34 is created on the basis of evaluation results of operators collected from a large number of users. Here, an outline of the collaborative filtering model 34 will be described with reference to FIGS. 3 and 4.

In the steps of creating and updating the collaborative filtering model 34, after the end of remote operation, the evaluation of the operator by the user is performed on, for example, a five-level scale from 1 of the lowest evaluation to 5 of the highest evaluation. The evaluation results are summarized in a table as shown in FIG. 3. FIG. 3 shows, as an example, evaluation results in the case where the number of users is five and the number of operators is five. The cell labeled “-” in the user x operator matrix shown in FIG. 3 represents an operator who has not been used by the user. For example, for User II, Operator A and Operator E have not been used, and for User V, Operator A and Operator C have not been used.

In the collaborative filtering model 34, alternative least square method is used for predicting an evaluation by a user with respect to an operator who has not been used by the user. The values enclosed in circles in FIG. 4 are evaluation values predicted by the alternative least square method. For example, the evaluation value of Operator A which has not been used by User II is predicted to be 5, and the evaluation value of Operator E is predicted to be 3. In the collaborative filtering model 34, a threshold value serving as a recommendation reference is set for the predicted evaluation value. If the threshold value is 4, then Operator A with the predicted evaluation value of 5 is recommended for User II. On the other hand, since there is no operator whose predicted evaluation value is 4 or more for the user V, the operator is not recommended by the collaborative filtering model 34.

The collaborative filtering model 34 is updated each time an evaluation result of an operator by a user is newly obtained or when predetermined amounts of evaluation results are accumulated. For example, when User II selects Operator A according to the recommendation this time, the evaluation result of Operator A by User II is obtained after the end of remote operation. The evaluation result is input to the matrix shown in FIG. 3 and is used to predict an evaluation value of an operator who has not been used by a user.

By using the collaborative filtering model 34 created as in the above-described example, it is possible to predict an operator who has not been used by a user requesting remote operation but is expected to be highly evaluated by the user from among standby operators. Generally, a user tends to be conservative in selecting an operator, but the collaborative filtering model 34 can recommend to the user an operator that is surprising to the user. Hereinafter, the operator recommended using the collaborative filtering model 34 will be referred to as an expected operator (expected remote operator).

Next, the popular operator table 35 will be described. The popular operator table 35 is a table created by summarizing the number of uses for each operator and ranking in descending order of the number of uses. The number of uses is one indicator of popularity of an operator. According to the popular operator table 35, it is possible to select the operator with the largest number of remote operations from among standby operators. The latest number of use times of each operator is reflected in the popular operator table 35.

The popular operator table 35 is used only for a new user who has no prior record of using the present recommendation system. Whether or not a user requesting remote operation is a new user is determined based on whether or not the user is registered in the user database 31. For a registered user registered in the user database 31, an operator is recommended by using the matching model 33 and the collaborative filtering model 34. For a new user not registered in the user database 31, one or more of the most popular operators available are recommended by using the popular operator table 35.

### 3. Remote Operator Recommendation Method

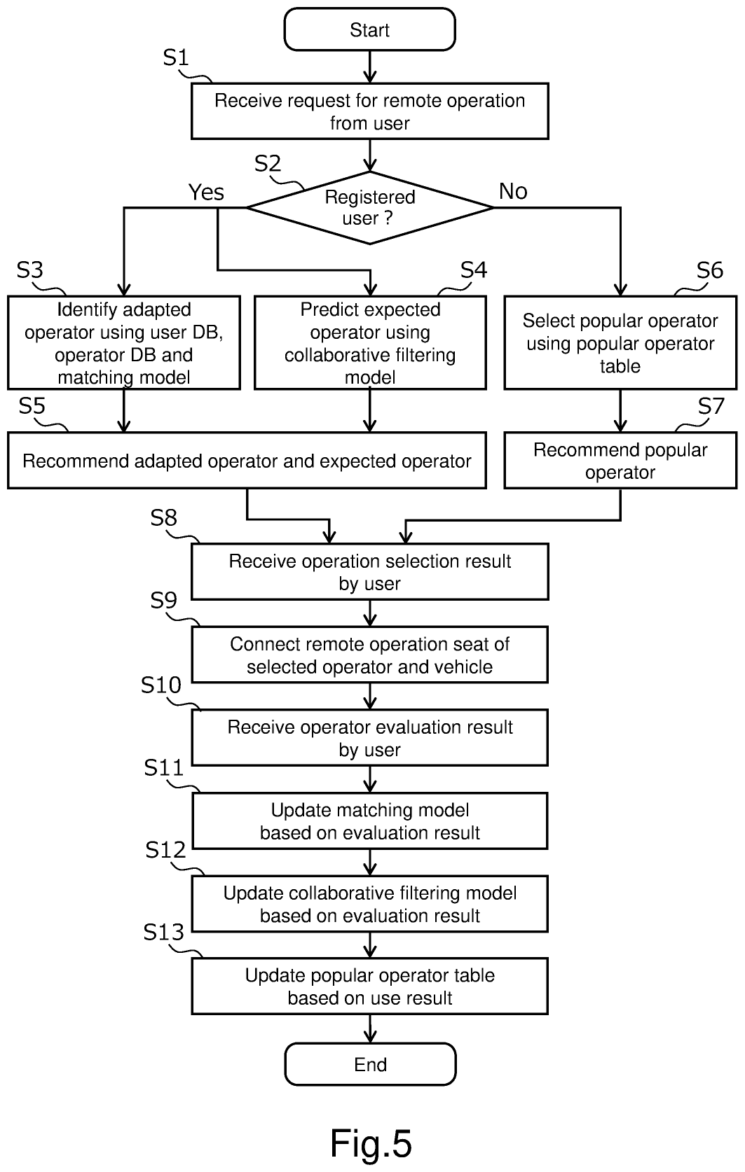

Next, a remote operator recommendation method executed by the recommendation system configured as described above will be described with reference to FIG. 5.

In step S1, the server 30 receives a request for remote operation from a requesting user requesting remote operation. The request for remote operation includes, for example, user identification information identifying the user, a departure location, a destination, and a start time of remote operation.

In step S2, the server 30 matches the user identification information to the user database 31 to determine whether the requesting user is a registered user or a new user. If the requesting user is a registered user, the server 30 executes steps S3 to S5. If the requesting user is a new user, the server 30 executes steps S6 and S7.

In step S3, the server 30 utilizes the user database 31, the matching model 33, and the operator database 32 to identify an adapted operator having an operator attribute adapted to the user attribute of the requesting user. The number of adapted operators identified in step S3 is one or more. That is, in the remote operation system 100, a large number of operators having various kinds of operator attributes are prepared so that there is at least one adapted operator.

In step S4, the server 30 predicts an expected operator who is expected to be highly evaluated by the requesting user by using the collaborative filtering model 34. The number of expected operators predicted in step S4 is zero or more. That is, depending on the result of collaborative filtering, there may be no expected operator.

In step S5, the server 30 presents both the adapted operator identified in step S3 and the expected operator predicted in step S4 as recommended operators to the requesting user. The recommended operators are presented on a display in the vehicle 20 or on a mobile terminal of the requesting user. The information of a recommended operator to be presented includes, for example, name, age, and gender. In addition, if the recommended operator permits to disclose, information such as driving history, nationality, hobbies and the like may be presented.

Meanwhile, in step S6, the server 30 selects one or more of the most popular operators from among available operators by using the popular operator table 35.

In step S7, the server 30 presents the popular operator selected in step S6 as a recommended operator to the requesting user.

The requesting user selects an operator to whom the requesting user requests remote operation from among the recommended operators recommended from the server 30. In step S8, the server 30 receives the operator selection result by the requesting user.

In step S9, the server 30 connects the vehicle 20 of the requesting user and the remote operation seat 40 of the operator selected by the requesting user via the communication network 10. This allows remote operation of the vehicle 20 by the operator.

The requesting user evaluates the operator in charge of remote operation. The evaluation is performed on, for example, a five-level scale. In step S10, the server 30 receives the evaluation result of the operator by the requesting user.

In step S11, the server 30 updates the matching model 33 based on the evaluation result of the operator in charge (remote operator in charge) by the requesting user. In step S12, the server 30 updates the collaborative filtering model 34 based on the evaluation result of the operator in charge by the requesting user. Further, in step S13, the server 30 updates the popular operator table 35 based on the result of use of the operator by the requesting user.

According to the remote operator recommendation method having the steps described above, a remote operator who has not been used by the requesting user but is expected to be highly evaluated by the requesting user is predicted using the collaborative filtering model. This makes it possible to recommend a new remote operator who may improve user satisfaction to the requesting user.

### 4. Other Embodiments

Travelling condition information may be added to the parameters of the matching model 33. The travelling condition information includes, for example, a region, weather, and time zone. By inputting the user attribute of the user requesting remote operation and the travelling condition information into the matching model 33, it is possible to recommend an operator having the most suitable operator attribute under the assumed travelling condition.

Attributes such as region, sex, and license may be added to the parameters of the popular operator table 35. A new user may select desired attributes so that popular operators recommended from the popular operator table 35 are narrowed down based on the attributes selected by the new user.

What is claimed is:

1. A remote operator recommendation system comprising:
a storage device storing a matching model and a collaborative filtering model; and
at least one processor coupled to the storage device,
wherein the at least one processor is configured to execute:
identifying, using the matching model, an adapted remote operator having an operator attribute adapted to a user attribute of a requesting user requesting remote operation of a vehicle from among standby remote operators;
predicting, using the collaborative filtering model, an expected remote operator who has not been used by the requesting user but is expected to be highly evaluated by the requesting user from among the standby remote operators; and
recommending the expected remote operator to the requesting user in addition to the adapted remote operator.

2. The remote monitoring system according to claim 1,
wherein the at least one processor is configured to further execute:
when the requesting user is a new user, recommending a remote operator with the highest number of times of remote operation among the standby remote operators.

3. The remote monitoring system according to claim 1,
wherein the at least one processor is configured to further execute:
after a remote operator in charge finishes remote operation, accepting an evaluation of the remote operator in charge from the requesting user; and
updating at least one of the matching model and the collaborative filtering model based on the evaluation of the remote operator in charge by the requesting user.

4. A remote operator recommendation method comprising:
identifying, using a matching model, an adapted remote operator having an operator attribute adapted to a user attribute of a requesting user requesting remote operation of a vehicle from among standby remote operators;
predicting, using a collaborative filtering model, an expected remote operator who has not been used by the requesting user but is expected to be highly evaluated by the requesting user from among the standby remote operators; and
recommending the expected remote operator to the requesting user in addition to the adapted remote operator.

5. A non-transitory computer-readable storage medium storing a program configured to cause a computer to execute processing comprising:
identifying, using a matching model, an adapted remote operator having an operator attribute adapted to a user attribute of a requesting user requesting remote operation of a vehicle, from among standby remote operators;
predicting, using a collaborative filtering model, an expected remote operator who has not been used by the requesting user but is expected to be highly evaluated by the requesting user from among the standby remote operators; and
recommending the expected remote operator to the requesting user in addition to the adapted remote operator.
